(19) United States
(12) Patent Application Publication
(10) Pub. No.: US 2018/0373629 A1
(43) Pub. Date: Dec. 27, 2018

(54) MEMORY SYSTEM AND OPERATING METHOD THEREOF

(71) Applicant: SK hynix Inc., Icheon-si (KR)

(72) Inventor: Min Kee KIM, Sejong-si (KR)

(73) Assignee: SK hynix Inc., Icheon-si Gyeonggi-do (KR)

(21) Appl. No.: 15/860,002

(22) Filed: Jan. 2, 2018

(30) Foreign Application Priority Data
Jun. 21, 2017 (KR) 10-2017-0078568

(51) Int. Cl. G06F 12/02; G06F 3/06; G06F 12/121

(52) U.S. Cl. CPC G06F 12/0253; G06F 3/0679; G06F 12/0238; G06F 2212/7205; G06F 3/0659; G06F 12/121; G06F 3/0619

(57) ABSTRACT

Disclosed are a memory system, which processes data, and an operating method of the memory system. The memory system includes: a memory device, including a plurality of memory blocks in which data is stored; and a controller, configured to perform a command operation corresponding to a command received from a host and a garbage collection operation. The controller stops the ongoing garbage collection operation when a system termination command is input from the host during the garbage collection operation, and transmits a signal corresponding to the system termination command to the host.

### CROSS-REFERENCE TO RELATED APPLICATION

The present application claims priority under 35 U.S.C. § 119(a) to Korean patent application number 10-2017-0078568 filed on Jun. 21, 2017 in the Korean Intellectual Property Office, the entire disclosure of which is incorporated herein by reference.

### BACKGROUND

### 1. Technical Field

The present disclosure relates to a memory system including a nonvolatile memory device, and more particularly, to a memory system which performs a garbage collection operation on a nonvolatile memory device, and an operating method thereof.

### 2. Related Art

Recently, computing devices have become ubiquitous, providing users with access to computing devices virtually anywhere at any time. Accordingly, the use of portable electronic devices, such as cellular phones, digital cameras, and notebook computers, has rapidly increased. Portable electronic device generally use memory systems, that is, data storage devices having memory devices. The data storage devices are used as main storage devices or as auxiliary memory devices of the portable electronic devices.

The data storage devices using the memory devices do not have mechanical driving units. This results in reduced stability and durability of the devices. Further, information access speed and power consumption can be improved over the state of the art.

### SUMMARY

The present disclosure is directed to solutions for the above-described problems associated with the prior art. Disclosed is a memory system, and an operating method thereof, capable of reducing data loss resulting from an abnormal termination of an ongoing garbage collection operation during a terminating operation of the memory system and a delay of a termination time of the memory system.

An exemplary embodiment of the present disclosure provides a memory system having: a memory device, which includes a plurality of memory blocks in which data is stored; and a controller, which is configured to perform a command operation corresponding to a command received from a host and a garbage collection operation. The command operation is performed in such a manner as to stop the ongoing garbage collection operation, when a system termination command is input from the host during the garbage collection operation, and to transmit a signal corresponding to the system termination command to the host.

Another exemplary embodiment of the present disclosure provides a memory system having: a memory device, which includes one or more system blocks and a plurality of memory blocks; and a controller configured to perform a command operation, corresponding to a command received from a host, and a garbage collection operation. When a system termination command is input during the garbage collection operation, the controller stops the ongoing garbage collection operation and then terminates the system. When the system is powered on after the termination of the system, the controller performs a booting operation and re-performs the stopped garbage collection operation from a stopped part.

Yet another exemplary embodiment of the present disclosure provides a method of operating a memory system. The method includes: providing a memory system having a memory device, including a plurality of memory blocks, and a controller, for controlling the memory device. The method further includes, when a command is input into the memory system from a host, performing a command operation corresponding to the command; and when a number of empty memory blocks among the plurality of memory blocks is smaller than a predetermined number, performing a garbage collection operation. The method also includes, when a system termination command is input from the host during the garbage collection operation, stopping the ongoing garbage collection operation, transmitting a response signal for the system termination command to the host, and terminating the memory system. The method additionally includes, when the memory system is powered on, performing a booting operation, and re-performing the stopped garbage collection operation from a stopped part after the booting operation.

In accordance with exemplary embodiments of the present disclosure, it is possible to reduce or eliminate data loss by an abnormal termination of an ongoing garbage collection operation during a terminating operation of a memory system and a delay of a termination time of the memory system.

### BRIEF DESCRIPTION OF THE DRAWINGS

Embodiments are described in detail below with reference to the accompanying drawings. Provided embodiments should not be construed as being limited to the descriptions and drawings as set forth herein. Those of ordinary skill in the art will appreciate that various modifications and changes can be made without departing from the scope of the teachings as set forth in the claims below. Accordingly, the specification and drawings are to be regarded in an illustrative rather than a restrictive sense, and all such modifications are intended to be included within the scope of present teachings.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a data processing system including a memory system according to an exemplary embodiment of the present disclosure.

FIG. 2 is a diagram illustrating a memory device in a memory system according to an exemplary embodiment of the present disclosure.

FIG. 3 is a diagram illustrating a memory cell array circuit of memory blocks in the memory device according to an exemplary embodiment of the present disclosure.

FIG. 4 is a diagram illustrating a structure of the memory device in the memory system according to an exemplary embodiment of the present disclosure.

FIG. 5 is a flowchart for describing a terminating operation of the memory system according to an exemplary embodiment of the present disclosure.

FIG. 6 is a diagram for describing an operation of a memory system according to an exemplary embodiment of the present disclosure.

FIG. 7 is a flowchart for describing a power-on operation of the memory system according to an exemplary embodiment of the present disclosure.

FIGS. 8 to 11 are diagrams illustrating other examples of a data processing system including the memory system according to an exemplary embodiment of the present disclosure.

### DETAILED DESCRIPTION

Advantages and features of the present disclosure and methods of achieving the advantages and features will be made clear with reference to exemplary embodiments described in detail below together with the accompanying drawings. However, the present disclosure is not limited to the exemplary embodiments described herein and may be implemented in various different forms. The exemplary embodiments described herein are provided so as to describe the present disclosure in detail so that those skilled in the art may easily understand and practice the teachings of the present disclosure.

Throughout this specification and the claims that follow, when it is described that an element is “coupled” to another element, the element may be “directly coupled” to the other element or “electrically coupled” to the other element through a third element. Throughout the specification and the claims, unless explicitly described to the contrary, the word “comprise” and variations such as “comprises” or “comprising” will be understood to imply the inclusion of stated elements but not the exclusion of any other elements.

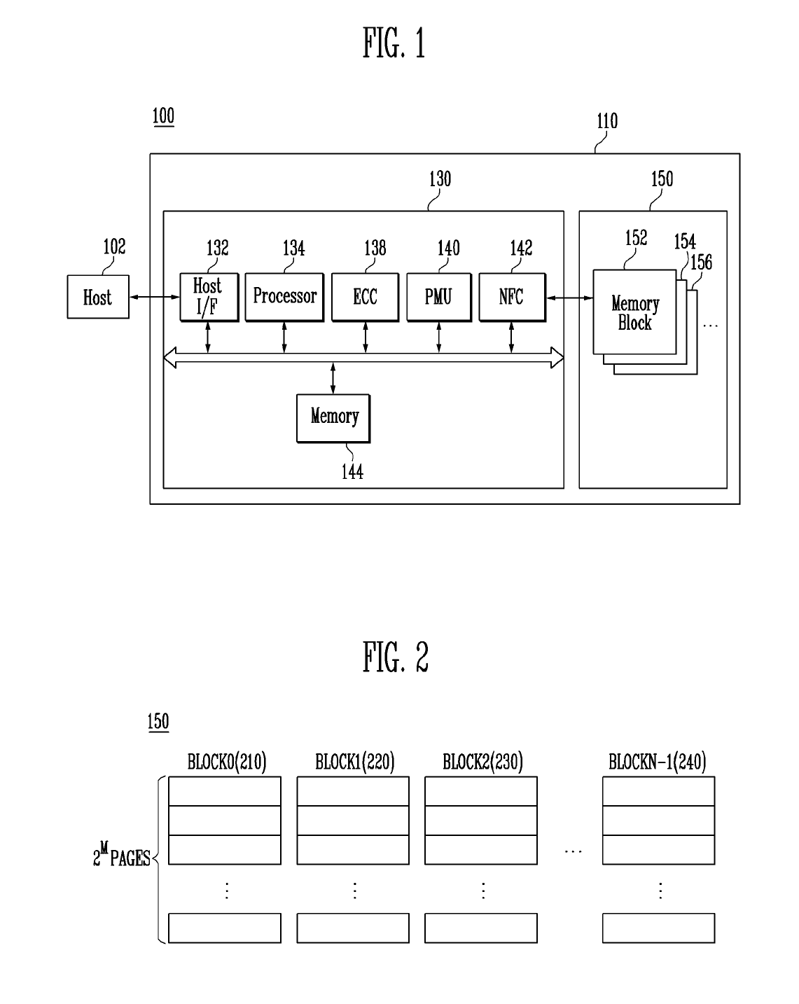

FIG. 1 is a diagram illustrating an example of a data processing system including a memory system. Referring to FIG. 1, a data processing system 100 includes a host 102 and a memory system 110.

The host 102 can be a portable electronic device, such as a cellular phone, an MP3 player, or a lap-top computer. The host 102 can also be a larger electronic device, such as a desktop computer, a gaming device, a TV, or a projector.

The memory system 110 operates in response to a request received from the host 102, and in particular, stores data accessed by the host 102. That is, the memory system 110 may be used as a main storage device or an auxiliary storage device of the host 102. Herein, the memory system 110 may be implemented with any one of various kinds of storage devices in accordance with a host interface protocol used by the host 102. For example, the memory system 110 may be implemented with any one of various kinds of storage devices, such as a Multi Media Card (MMC) in a form of a Solid State Drive (SSD), an embedded MMC (eMMC), a Reduced Size MMC (RS-MMC), a micro-MMC, a Secure Digital (SD) card in a form of an SD, a mini-SD, a micro-SD, a Universal Storage Bus (USB) storage device, a Universal Flash Storage (UFS) device, a Compact Flash (CF) card, a smart media card, or a memory stick.

Storage devices implementing the memory system 110 may be implemented with a volatile memory device, such as a Dynamic Random Access Memory (DRAM) or a Static RAM (SRAM). Storage devices implementing the memory system 110 may also be implemented with a nonvolatile memory device, such as a Read Only Memory (ROM), a Mask ROM (MROM), a Programmable ROM (PROM), an Erasable ROM (EPROM), an Electrically Erasable ROM (EEPROM), a Ferromagnetic ROM (RFAM), a Phase change RAM (PRAM), a Magnetic RAM (MRAM), a Resistive RAM (RRAM), or a flash memory.

The memory system 110 includes a memory device 150, which stores data accessed by the host 102, and a controller 130, which controls data storage in the memory device 150. Herein, the controller 130 and the memory device 150 may be integrated as one semiconductor device. For example, the controller 130 and the memory device 150 may be integrated and configured as an SSD. In a case where the memory system 110 is used as an SSD, the speed of an operation of the host 102 connected to the memory system 110 may be remarkably improved.

The controller 130 and the memory device 150 may be integrated as one semiconductor device configured as a memory card. Such memory cards can include, but are not limited to, a PC card (Personal Computer Memory Card International Association (PCMCIA)), a Compact Flash (CF) card, smart media cards (SM and SMC), a memory stick, multimedia cards (MMC, RS-MMC, and MMCmicro), SD cards (SD, miniSD, microSD, and SDHC), and a universal flash storage (UFS).

The memory system 110 may be part of or used with a computer, an ultra mobile PC, a workstation, a net-book computer, personal digital assistants (PDAs), a portable computer, a web tablet PC, a table computer, a wireless phone, a mobile phone, a smart phone, an e-book reader, a portable multimedia player (PMP), a portable game device, a navigation device, a black box, a digital camera, a digital Multimedia Broadcasting (DMB) player, a three-dimensional (3-D) television, a smart television, a digital audio recorder, a digital audio player, a digital picture recorder, a digital picture player, a digital video recorder, a digital video player, a storage configuring a data center, a device capable transceiving information in a wireless environment, one of various electronic devices configuring a home network, one of various electronic devices configuring a computer network, one of various electronic devices configuring a telematics network, a Radio Frequency Identification (RFID) device, one of various constituent element devices configuring a computing system, or any other computing device.

The memory device 150 of the memory system 110 may maintain stored data even when power is not supplied, and in particular, stores data provided by the host 102 through a write operation and provides stored data to the host 102 through a read operation.

The memory device 150 includes a plurality of memory blocks 152, 154, 156 with each of the memory blocks 152, 154, 156 including a plurality of pages. Further, each of the pages includes a plurality of memory cells connected to a plurality of word lines. Further, the memory device 150 includes a plurality of planes, in which the plurality of memory blocks 152, 154, 156 is included, respectively, and in particular, may include a plurality of memory dies in which the plurality of planes is included, respectively. The memory device 150 may be a nonvolatile memory device, for example, a flash memory, and in this case, the flash memory may have a three-dimensional stack structure. Further, at least one memory block among the plurality of memory blocks 152, 154, 156 of the memory device 150 may be defined as a system block. System data related to the memory device 150 and context for garbage collection may be stored together in the system block. For other embodiments, a system block may be defined as predetermined areas assigned from each of the plurality of memory blocks 152, 154, 156. In accordance with the teachings herein, the term “system block” written in the singular can also mean “system blocks,” in the plural sense, and vice versa.

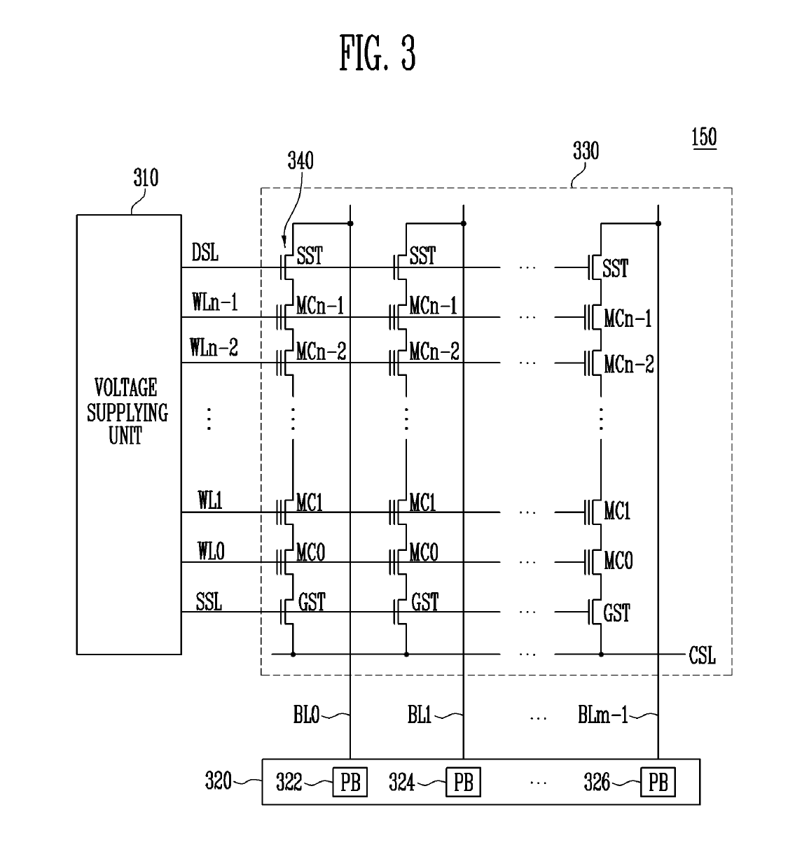

The structure of the memory device 150 and a 3-D stack structure of the memory device 150 is described in more detail with reference to FIGS. 2 to 4.

The controller 130 of the memory system 110 controls the memory device 150 in response to a request from the host 102. The controller 130 provides data read from the memory device 150 to the host 102 and stores data provided by the host 102 in the memory device 150. For a number of embodiments, the controller 130 controls read operations, write operations, program operations, and/or erase operations of the memory device 150.

The controller 130 is shown to include a host Interface (I/F) unit 132, a processor 134, an Error Correction Code (ECC) 138, a Power Management Unit (PMU) 140, a NAND Flash Controller (NFC) 142, and a memory 144.

The host I/F unit 134 may be configured to process commands and data of the host 102, and to communicate with the host 102 through at least one of various interface protocols, such as a USB, an MMC, a Peripheral Component Interconnect-Express (PCI-E), a Serial-attached SCSI (SAS), a Serial Advanced Technology Attachment (SATA), a Parallel Advanced Technology Attachment (PATA), a Small Computer System Interface (SCSI), an Enhanced Small Disk Interface (ESDI), and Integrated Drive Electronics (IDE).

When the data stored in the memory device 150 is read, the ECC unit 138 may detect and correct an error included in the data read from the memory device 150. That is, the ECC unit 138 may perform error correction decoding on data read from the memory device 150, determine whether the error correction decoding is successful, and output an instruction signal according to a result of the determination, and correct an error bit of the read data by using a parity bit generated during an ECC encoding process. For an embodiment, when the number of error bits generated is equal to or larger than a correctable error bit limit value, the ECC unit 138 does not correct the error bits and outputs an error correction fail signal corresponding to a failure of the correction of the error bits.

The ECC unit 138 may perform error correction by using coded modulation, such as a Low Density Parity Check (LDPC) code, Bose, a Chaudhri, Hocquenghem (BCH) code, a turbo code, a Reed-Solomon code, a convolution code, a Recursive Systematic Code (RSC), Trellis-Coded Modulation (TCM), or Block Coded Modulation (BCM). Further, the ECC unit 138 may include one or more circuits, a system, or a device for correcting errors.

The PMU 140 provides and manages power for the controller 130. The PMU 140, for example, supplies current at the voltage or voltages necessary for the elements 132, 134, 138, 142, 144 included in the controller 130 to perform their intended functionality.

The NFC 142 is a memory interface performing interfacing between the controller 130 and the memory device 150 in order for the controller 130 to control the memory device 150 in response to a request from the host 102. When the memory device 150 is a flash memory, such as a NAND flash memory, for example, the NFC 142 generates a control signal of the memory device 150 and processes data under the control of the processor 134.

The memory 144 is an operation memory of the memory system 110 and the controller 130. In one embodiment, the memory 144 stores data for driving the memory system 110 and the controller 130. For example, when the controller 130 controls an operation, such as a read operation, a write operation, a program operation, or an erase operation of the memory device 150, the controller 130 stores data used for performing the operation in the memory 144.

System data stored in the system block of the memory device 150 and context for garbage collection are read and stored in the memory 144 during a booting operation of the memory system 110. The memory 144 may store the context for the garbage collection in the memory device 150 during a terminating operation of the memory system 110.

The memory 144 may be implemented with a volatile memory. Further, the memory 144 may be implemented with a Static Random Access Memory (SRAM) or a Dynamic Random Access Memory (DRAM). The memory 144 stores data used for performing operations, such as data write and read operations, between the host 102 and the memory device 150. For the performance of operations, such as the data write and read operations indicated above, and for the storage of other data, the memory 144 can implement a program memory, a data memory, a write buffer/cache, a read buffer/cache, a map buffer/cache, and the like.

The processor 134 controls general operations of the memory system 110 and controls write and/or read operations for the memory device 150 in response to write and/or read requests, respectively, from the host 102. For some embodiments described herein, the processor 134 drives Flash Translation Layer (FTL) firmware for controlling the general operation of the memory system 110. Further, the processor 134 may be implemented with one or more microprocessors, a Central Processing Unit (CPU), and/or an auxiliary processing unit.

The controller 130 performs an operation, requested by the host 102, in the memory device 150. That is, the controller 130 performs a command operation, corresponding to a command received from the host 102, with the memory device 150 using the processor 134. Herein, the controller 130 may perform a foreground operation through the command operation corresponding to the command received from the host 102.

The controller 130 may also perform a background operation for the memory device 150 using the processor 134 implemented as a microprocessor, such as a CPU. Herein, the background operation for the memory device 150 can include an operation of copying data stored in a predetermined memory block among the memory blocks 152, 154, 156 of the memory device 150 into another predetermined memory block and processing the data. Such an operation, for example, can include a Garbage Collection (GC) operation, an operation of swapping and processing the memory blocks 152, 154, 156 of the memory device 150 or data stored in the memory blocks 152, 154, 156 of the memory device 150, a Wear Leveling (WL) operation, an operation of storing map data stored in the controller 130 in the memory blocks 152, 154, 156 of the memory device 150, a map flush operation, and a band management operation for the memory device 150, or a bad block management operation of checking and processing a bad block in the plurality of memory blocks 152, 154, 156 included in the memory device 150.

Within the memory system 110, in accordance with an exemplary embodiment of the present disclosure, the controller 130 performs the command operation corresponding to the command received from the host 102. The controller performs, for example, a program operation corresponding to a write command, or a read operation corresponding to a read command, with the memory device 150, and updates metadata and map data corresponding to the performance of the command operation. Further, when a system termination command is input from the host 102 during a garbage collection operation in the memory system 110, the memory system 110 may stop the ongoing garbage collection operation, generate context for the stopped garbage collection, and store the system data and the context in the system block of the memory device 150.

Garbage collection, as used herein, refers to reclaiming memory occupied by objects that are no longer in use by a program executing on a computing device. Terminating the memory system 110, as used herein, means to shut down or power down the memory system 110.

When the memory system 110 is powered on again, the controller 130 performs the booting operation and reads the system data and the context for the stopped garbage collection from the system block of the memory device 150 to perform the booting operation. For example, the controller 130 reads and stores the system data and the context stored in the system block during the power-on operation and performs the booting operation according to the stored system data.

After the booting operation, the controller 130 re-performs the garbage collection operation from a stopped part by using the read context for the garbage collection. For some embodiments, re-performing the garbage collection operation from a stopped part means resuming the garbage collection operation from the point at which the garbage collection operation was stopped in response to a termination command received from the host 102.

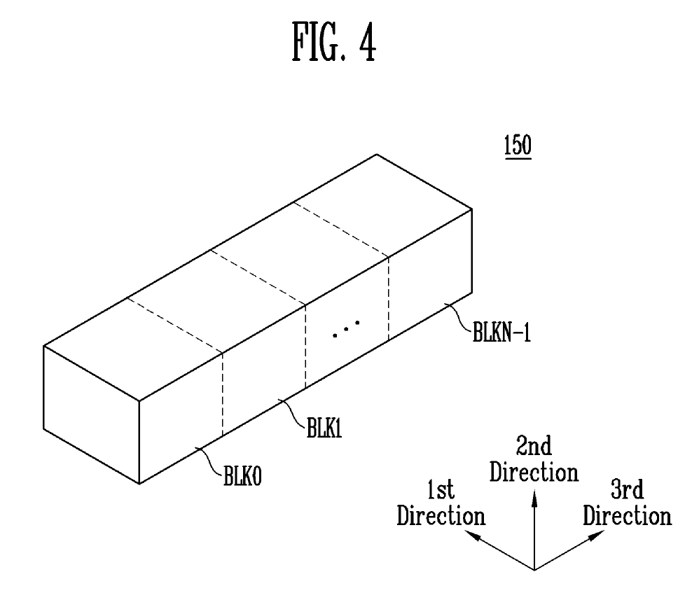

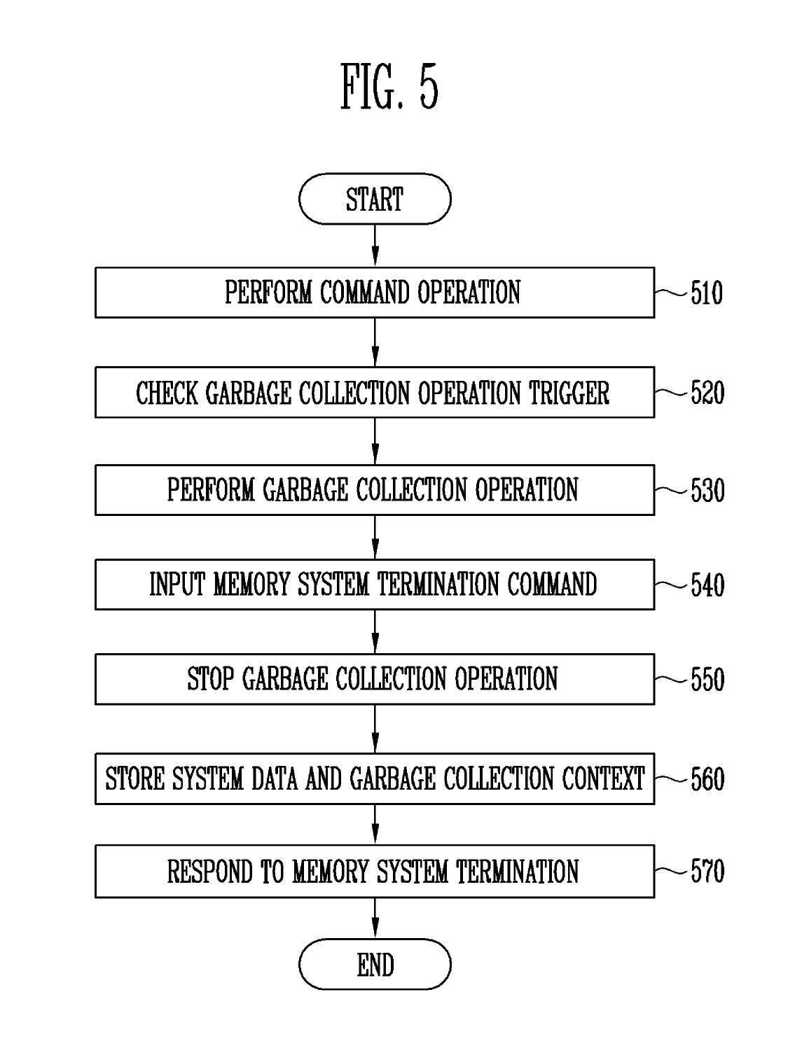

FIG. 2 is a diagram illustrating the memory device 150 in the memory system 110 according to an exemplary embodiment of the present disclosure. FIG. 3 is a diagram illustrating a memory cell array circuit of the memory blocks 152, 154, 156 in the memory device 150 according to an exemplary embodiment of the present disclosure. FIG. 4 is a diagram illustrating a structure of the memory device 150 in the memory system 110 according to an exemplary embodiment of the present disclosure. The memory device 150 in the memory system 110 will be described in more detail with reference to FIGS. 2 to 4.

Referring to FIG. 2, the memory device 150 includes a plurality of memory blocks, for example, block 0 (BLK0) 210, block 1 (BLK1) 220, block 2 (BLK2) 230, and block N-1 (BLKN-1) 240. Each of the blocks 210, 220, 230, 240 includes a plurality of pages, for example, 2M pages, as shown. While the blocks 210, 220, 230, 240 are shown and described as having 2M pages, the blocks 210, 220, 230, 240 may have different numbers of pages in different embodiments. Each of the pages includes a plurality of memory cells connected with a plurality of word lines.

The memory device 150 may include the plurality of memory blocks 210, 220, 230, 240 as Single-Level Cell (SLC) memory blocks and/or as Multi-Level Cell (MLC) memory blocks according to the number of bits of data which may be stored in one memory cell. Herein, SLC memory blocks include a plurality of pages implemented by memory cells storing 1 bit data in one memory cell and have fast data calculation performance and high durability. MLC memory blocks include a plurality of pages implemented by memory cells storing multi-bit data (for example, 2 bits or more) in one memory cell and may have larger data storage spaces than the SLC memory blocks. MLC memory blocks including a plurality of pages implemented by memory cells which are capable of storing 3- or 4-bit data in one memory cell may also be divided into a Triple-Level Cell (TLC) memory blocks or Quad-Level Cell (QLC) memory blocks.

Each of the blocks 210, 220, 230, 240 stores data provided by the host 102 through a write operation, and provides the stored data to the host 102 through a read operation. Further, one or more blocks, for example, block 0 (BLK0) 210, among the plurality of blocks 210, 220, 230, 240 may be defined as the system block, and system data and context for the garbage collection operation may be stored in the system block. The system data stored during the booting operation of the memory system 110 and the context for the garbage collection operation are read and stored in the controller 130 of FIG. 1. The context for the garbage collection may be programmed during the terminating operation of the memory system 110.

Referring to FIG. 3, each memory block 330 in the plurality of memory blocks 210, 220, 230, 240 included in the memory device 150 of the memory system 110 may include a plurality of cell strings 340 which are implemented with memory cell arrays and are connected to bit lines BL0 to BLm-1, respectively. The cell string 340 of each column may include one or more drain select transistors DST and one or more source select transistors SST. The plurality of memory cells MC0 to MCn-1 may be serially connected between the select transistors DST and SST. Each of the memory cells MC0 to MCn-1 may be formed as the MML storing data information of a plurality of bits per cell. The cell strings 340 may be electrically connected to the corresponding bit lines BL0 to BLm-1, respectively.

FIG. 3 illustrates each memory block 330 formed of the NAND flash memory cell, but the plurality of memory blocks 152, 154, 156 included in the memory device 150 is not limited to the NAND flash memory. The memory blocks 152, 154, 156 may also be implemented with a NOR-type flash memory, a hybrid flash memory in which two or more kinds of memory cells are combined, a one-NAND flash memory in which a controller is embedded inside a memory chip, and the like. Further, the memory device 150 may also be implemented with a flash memory device, in which a charge storing layer is formed of a conductive floating gate, a Charge Trap Flash (CFT) memory device, in which a charge storing layer is formed of an insulating layer, and the like.

A voltage supplying unit 310 of the memory device 150 may provide word line voltages (for example, a program voltage, a read voltage, and a pass voltage) to the word lines, respectively, according to an operation mode, and a voltage to be supplied to a bulk (for example, a well region), in which the memory cells are formed. In this case, a voltage generating operation of the voltage supplying circuit 310 may be performed under a control of a control circuit (not illustrated). Further, the voltage supplying unit 310 may generate a plurality of variable read voltages for generating a plurality of elements of read data, and may select one of the memory blocks (or sectors) of the memory cell array in response to the control of the control circuit and select one of the word lines of the selected memory block, and provide the word line voltage to each of the selected word line and non-selected word lines.

A read/write circuit 320 of the memory device 150 may be controlled by the control circuit, and may be operated as a sense amplifier or a write driver according to an operation mode. For example, in a case of a verify/normal read operation, the read/write circuit 320 may be operated as a sense amplifier for reading data from the memory cell array. Further, in a case of a program operation, the read/write circuit 320 may be operated as a write driver for driving bit lines according to data to be stored in the memory cell array. The read/write circuit 320 may receive data to be written in the cell array during the program operation from a buffer (not illustrated), and drive the bit lines according to the input data. To this end, the read/write circuit 320 may include a plurality of page buffers PB 322, 324, and 326 corresponding to columns (or bit lines) or column pairs (or the pair of bit lines), respectively, and a plurality of latches (not illustrated) may be included in the page buffers 322, 324, and 326, respectively.

The memory device 150 may be implemented with a 2-D or 3-D memory device. In particular, as illustrated in FIG. 4, the memory device 150 may be implemented with a non-volatile memory device having a 3-D stack structure. When the memory device 150 is implemented with the 3-D structure, the memory device 150 may include the plurality of memory blocks BLK0 to BLKN-1. FIG. 4 is a block diagram illustrating the memory blocks 152, 154, 156 of the memory device 150 illustrated in FIG. 1, and each of the memory blocks 152, 154, 156 may be implemented in a 3-D structure (or vertical structure). For example, each of the memory blocks 152, 154, 156 may include structures elongated in a first, second, and/or third direction, as illustrated. In one embodiment, the first, second, and third directions correspond to an x-axis direction, a y-axis direction, and a z-axis direction, respectively, in a Cartesian coordinate system.

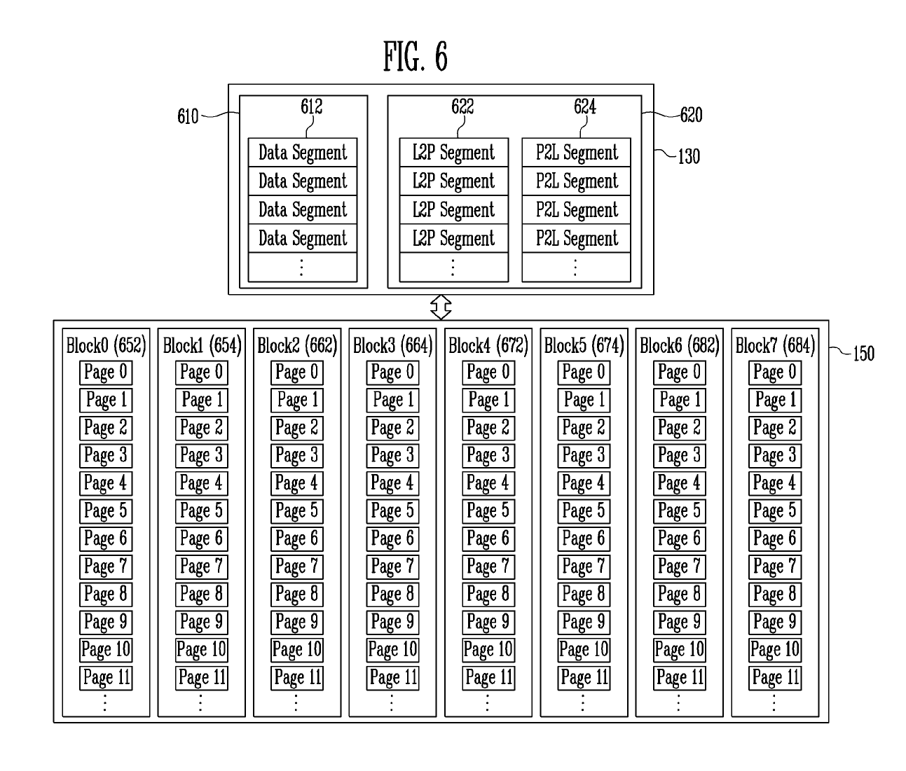

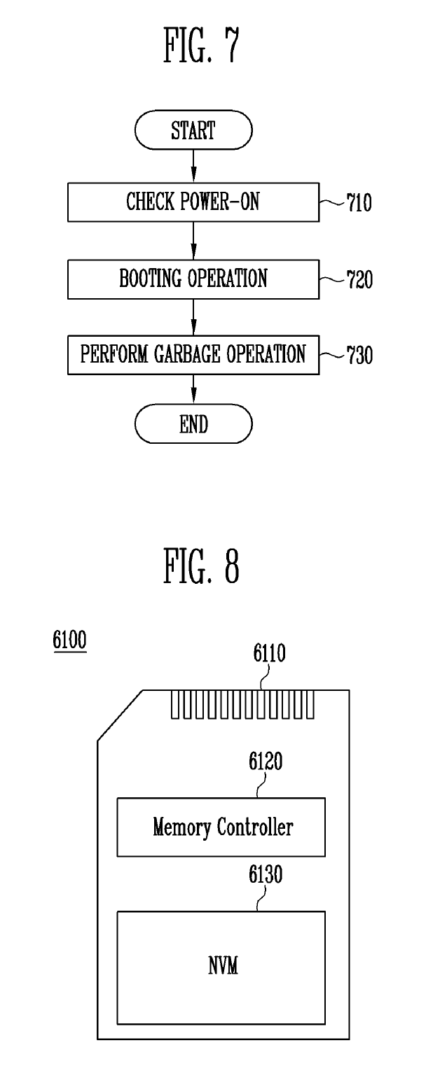

FIG. 5 shows a flowchart for describing a terminating operation of the memory system according to an exemplary embodiment of the present disclosure. FIG. 6 shows a diagram for describing an operation of the memory system 110 according to an exemplary embodiment of the present disclosure. A terminating operation of the memory system 110 according to an embodiment will be described with reference to FIGS. 5 and 6.

A case where the memory system 110, illustrated in FIG. 1, performs a command operation corresponding to a command received from the host 102, for example, a program operation corresponding to a write command received from the host 102 and a system terminating command input from the host while the garbage collection operation is performed, will be described in detail.

The case where the controller 130 performs the data processing operation in the memory system 110 is described as an example, but as described above, the processor 134 included in the controller 130 may also perform the data processing operation through the FTL. The controller 130 stores user data corresponding to a write command received from the host 102 and metadata in the buffer included in the memory 144 of the controller 130. The controller 130 then programs the data stored in the buffer in a predetermined memory block, except for the system block, in the plurality of memory blocks included in the memory device 150.

Referring to FIG. 5, the memory system 110 performs a command operation corresponding to a command received from the host 102 in operation 510. For example, the memory system 110 performs a program operation corresponding to a write command received from the host 102. Data segments of user data corresponding to the command received from the host 102 are stored in the memory 144 of the controller 130, and then are programmed and stored in pages included in the memory blocks 652, 654, 662, 664, 672, 674, 682, and 684 (see FIG. 6) of the memory device 150. Metasegments of metadata corresponding to the data segments are stored in the memory 144 of the controller 130 in correspondence to the storage of the data segments in the pages included in the memory blocks of the memory device 150. The metasegments are then programmed and stored in pages included in the memory blocks 652, 654, 662, 664, 672, 674, 682, and 684 of the memory device 150.

The metadata includes first map data, including logical to physical (L2P) information (hereinafter, referred to as “logical information”) for the data stored in the memory blocks in correspondence to the program operation, and second map data, including physical to logical (P2L) information (hereinafter, referred to as “physical information”), and further, may include information about command data corresponding to a command received from the host 102, information about a command operation corresponding to a command, information about the memory blocks of the memory device 150 in which the command operation is performed, and information about map data corresponding to the command operation. That is, the metadata may include all of the remaining information and data except for the user data corresponding to the command received from the host 102.

The user data corresponding to the write command is stored in empty memory blocks (open memory blocks or free memory blocks) in which an erase operation is performed among the memory blocks of the memory device 150. The first map data including an L2P map table or an L2P map list in which mapping information between a logical address and a physical address, that is, logical information, for the user data is stored in the memory blocks of the memory device 150. The second map data including a P2L map table or a P2L map list in which mapping information between a physical address and a logical address, that is, physical information, for the memory blocks in which the user data is stored are stored in the empty memory blocks (the open memory blocks or the free memory blocks) among the memory blocks of the memory device 150.

When the controller 130 receives the write command from the host 102, the controller 130 stores the user data corresponding to the write command in the memory blocks. The controller 130 stores the metadata for the user data, including the first map data, the second map data, and the like, in the memory blocks. In particular, the controller 130 generates and updates L2P segments of the first map data and P2L segments of the second map data as metasegments of the metadata. That is, the controller 130 stores map segments of the map data, in correspondence with the storage of the data segments of the user data in the memory blocks of the memory device 150, and stores the L2P segments of the first map data and the P2L segments of the second map data in the memory blocks of the memory device 150, and in this case, the controller 130 loads the map segments stored in the memory blocks of the memory device 150 to the memory 144 included in the controller 130 to update the map segments.

In an embodiment, the controller 130 caches and buffers the user data corresponding to the write command received from the host 102 in the first buffer 610 included in the memory 144 of the controller 130. That is, the controller 130 stores the data segments 612 of the user data in the first buffer 610, which is a data buffer/cache, and then writes and stores the data segments 612 stored in the first buffer 610 in pages included in the memory blocks 652, 654, 662, 664, 672, 674, 682, 684 of the memory device 150.

The controller 130 generates and updates the first map data and the second map data according to the writing and the storage of the data segments 612 of the user data corresponding to the write command received from the host 102 in the pages included in the memory blocks 652, 654, 662, 664, 672, 674, 682, 684 of the memory device 150, and the controller 130 stores the first map data and the second map data in a second buffer 620 included in the memory 144 of the controller 130. That is, the controller 130 stores the L2P segments 622 of the first map data and the P2L segments 624 of the second map data for the user data in the second buffer 620, which is the map buffer/cache. In the memory 144 of the controller 130, the L2P segments 622 of the first map data and the P2L segments 624 of the second map data, or a map list for the L2P segments 622 of the first map data and a map list of the P2L segments 624 of the second map data, may be stored in the second buffer 620. Further, the controller 130 may write and store the L2P segments 622 of the first map data and the P2L segments 624 of the second map data stored in the second buffer 620 in the pages included in the memory blocks 652, 654, 662, 664, 672, 674, 682, 684 of the memory device 150.

In operation 520, a garbage collection operation trigger check operation is performed. For example, whether to perform the garbage collection operation is determined by comparing the number of empty memory blocks (also referred to as open memory blocks or free memory blocks) in which the erase operation is performed among the memory blocks with a predetermined number. For example, when it is determined that the number of free memory blocks is equal to or smaller than the predetermined number, the garbage collection operation is performed. When it is determined that the number of free memory blocks is larger than the predetermined number, the ongoing program operation corresponding to the write command is continuously performed. The garbage collection operation trigger check operation may be performed during the command operation 510 corresponding to the command received from the host 102 or after the command operation is terminated.

When it is determined that the number of free memory blocks is equal to or smaller than the predetermined number as a result of the garbage collection operation trigger check operation 520, the garbage collection operation is performed (530).

When the write command is received from the host 102 for the user data programmed in the pages of the memory blocks, the user data is programmed and stored in other pages included in the memory blocks of the memory device 150. The user data stored in the pages of the previous memory blocks become invalid data, and the pages, in which the user data is stored, in the previous corresponding memory blocks become invalid pages. When the number of invalid pages is increased in the corresponding memory blocks, memory efficiency is degraded.

When the invalid pages are included in the memory blocks of the memory device 150 as described above, the garbage collection operation for the memory blocks of the memory device 150 is performed in order to further increase or maximize use efficiency of the memory device 150.

The controller 130 may confirm valid pages in the memory blocks of the memory device 150 and then perform the garbage collection operation according to a parameter, for example, a Valid Page Count (VPC, hereinafter, referred to as a “VPC”) of the memory blocks to perform an empty memory block (open memory block or free memory block).

The controller 130 may perform the garbage collection operation on the valid pages included in the memory blocks, in which the program operation is completed, that is, the memory blocks in which the data program operation is performed for all of the pages included in each memory block, among the memory blocks of the memory device 150. That is, the controller 130 performs the garbage collection operation in consideration of the VPC as the parameter of the memory blocks, and particularly, copies valid data of the valid pages included in the memory blocks into the memory block, for example, an empty memory block (open memory block or free memory block), in which the data program operation is not performed, and stores the valid data. That is, the controller 130 selects source memory blocks from the memory blocks of the memory device 150 in consideration of the VPC that is the parameter for the memory blocks of the memory device 150, copies valid data stored in the valid pages of the source memory blocks into pages of target memory blocks and stores the valid data. Herein, the controller 130 selects the empty memory blocks (open memory blocks or free memory blocks) in the memory blocks of the memory device 150 as target memory blocks.

In a particular embodiment, during the garbage collection operation, the controller copies and stores data of valid pages included in a source block, in which a program operation is completed, to a target block, in which the program operation is not performed. Here, the plurality of memory blocks 152, 154, 156 of the memory system 110 includes the source block and the target block. Then, the number of empty memory blocks (open memory blocks or free memory blocks) is increased by performing the erase operation on the source memory block.

When a termination command of the memory system 110 is input from the host 102 during the garbage collection operation (540), the controller 130 stops the ongoing garbage collection operation (550).

Further, the controller 130 generates context for the ongoing garbage collection operation in response to the termination command and stores the generated context in the system block of the memory device 150 together with the system data (560). Information, such as information indicating whether the ongoing garbage collection operation is normally performed, an address of the last page of the source block, and/or an address of the last page of the target block, may be included in the context.

Then, the controller 130 stops all of the operations of the memory system 110 and outputs a signal, corresponding to the termination command, to the host 102 (570). For an embodiment, the corresponding signal needs to be output to the host 102 within a predetermined time after the termination command is input into the host 102. After the corresponding signal is transmitted to the host 102, the memory system 110 is powered off.

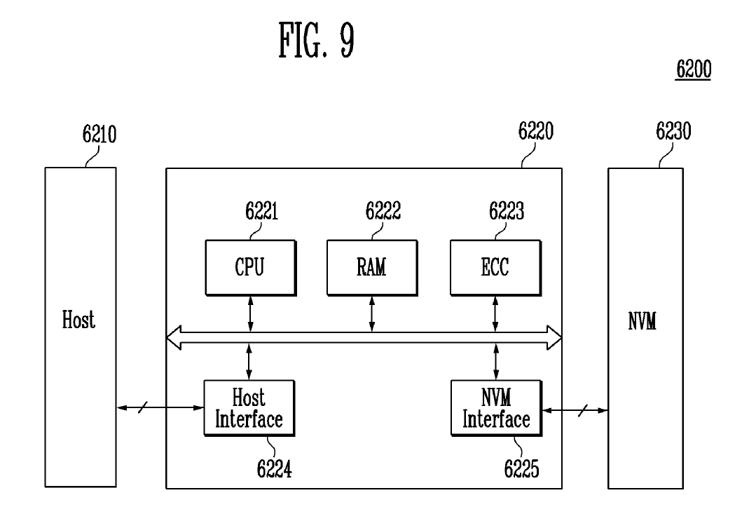

FIG. 7 shows a flowchart for describing an operation of the memory system 110 during power-on after the terminating operation. The power-on operation of the memory system 110, according to an embodiment, will be described below with reference to FIGS. 1 to 4, and 7.

When a power voltage is applied to the memory system 110 and it is confirmed that the memory system 110 is in a powered on state (710), the controller 130 performs a booting operation (720). During the booting operation, the controller 130 reads the system data stored in the system block included in the memory device 150 and the context for the garbage collection operation and stores the read context in the memory 144 of the memory system 110. When a command is input from the host 102 based on the stored system data, the controller 130 performs a booting operation so as to perform a command operation corresponding to the command.

When the booting operation is completed, the controller 130 checks whether the garbage collection operation, which is stopped during the immediately previous terminating operation of the system, is operated based on the context for the garbage collection operation stored in the memory 144, and when there is the stopped garbage collection operation, the controller 130 performs the garbage collection operation again from a stopped part by using the address of the last page of the source block and the address of the last page of the target block and normally completes the garbage collection operation (730). For a particular embodiment, the context stored in the system block is read during the booting operation, and the stopped garbage collection operation is re-performed from a stopped part based on the read context after the booting operation is completed.

As described above, when the termination command is input from the host 102 during the garbage collection operation of the memory system 110, the controller 130 stops the ongoing garbage collection operation, generates context for the stopped garbage collection operation, and stores the generated context in the system block. Accordingly, the controller 130 may output a response signal responding to the terminating command to the host 102 before the garbage collection operation is normally completed. For an embodiment, a termination time of the garbage collection operation is longer than a response time, for which the response needs to be made to the termination command, so that the garbage collection operation is stopped by powering off to relieve data loss by sudden power loss.

The stopped garbage collection operation is completed by performing the booting operation during the powering on of the memory system 110 based on the context of the garbage collection operation. The garbage collection operation is then re-performed from the stopped part.

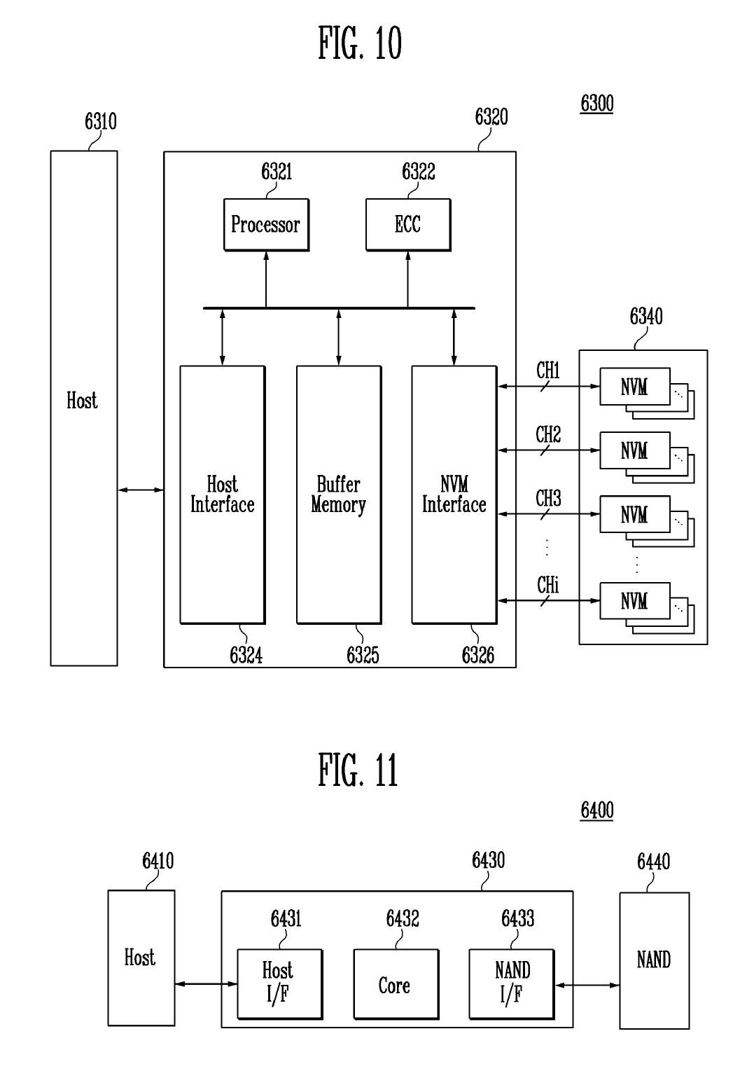

FIG. 8 is a diagram schematically illustrating another example of a data processing system including the memory system 110 according to an exemplary embodiment of the present disclosure. In particular, FIG. 8 schematically illustrates a memory card system.

Referring to FIG. 8, a memory card system 6100 includes a memory controller 6120, a memory device 6130, and a connector 6110. The memory controller 6120 is connected with the memory device 6130, implemented with a nonvolatile memory, and configured to access the memory device 6130. For example, the memory controller 6120 is configured to control read, write, erase, and perform background operations of the memory device 6130. Further, the memory controller 6120 is configured to provide an interface between the memory device 6130 and a host, and is configured to drive firmware for controlling the memory device 6130. For some embodiments, the memory controller 6120 may correspond to the controller 130 in the memory system 110 described with reference to FIG. 1, and the memory device 6130 may correspond to the memory device 150 in the memory system 110 described with reference to FIG. 1.

The memory controller 6120 may include constituent elements, such as a Random Access Memory (RAM), a processing unit, a host interface, a memory interface, and an error correcting unit. Further, the memory controller 6120 may communicate with an external device, for example, with the host 102, described with reference to FIG. 1, through the connector 6110. The memory controller 6120 may be configured to communicate with an external device through at least one of various communication standards, such as a Universal Serial Bus (USB), a Multimedia Card (MMC), an embedded MMC (eMMC), a Peripheral Component Interconnection (PCI), PCI express (PCIe), Advanced Technology Attachment (ATA), Serial-ATA, Parallel-ATA, a Small Computer Small Interface (SCSI), an Enhanced Small Disk Interface (ESDI), Integrated Drive Electronics (IDE), Firewire, a Universal Flash Storage (UFS), WIFI, and/or Bluetooth, as described with reference to FIG. 1. The memory system 110 and the data processing system may be applied to wired and wireless electronic devices, and in particular, to mobile electronic devices.

The memory device 6130 may be implemented with a nonvolatile memory, for example, various nonvolatile memory devices. Such nonvolatile memory devices can include an Electrically Erasable and Programmable ROM (EPROM), a NAND flash memory, a NOR flash memory, a Phase-change RAM (PRAM), a Resistive RAM (ReRAM), a Ferroelectric RAM (FRAM), and/or a Spin-Torque Magnetic RAM (STT-MRAM).

For an embodiment, the memory controller 6120 and the memory device 6130 may be integrated together as one semiconductor device. For example, the memory controller 6120 and the memory device 6130 may be integrated together as a semiconductor device to configure a Solid State Drive (SSD), and may configure a memory card, such as a PC card (PCMCIA), a Compact Flash card (CF), a smart media card (SM and SMC), a memory stick, a Multimedia Card (MMC, RS-MMC, MMCmiro, and eMMC), an SD card (SD, miniSD, microSD, and SDHC), and/or a Universal Flash storage (UFS).

FIG. 9 is a diagram schematically illustrating another example of a data processing system, which includes the memory system 110. Referring to FIG. 9, a data processing system 6200 includes a memory device, implemented with one or more nonvolatile memory devices, and a memory controller 6220, controlling the memory device 6230. The data processing system 6200 may be a storage medium, such as a memory card (a CF card, an SD card, a microSD card, and the like) or a USB storage device, as described with reference to FIG. 1. For some embodiments, the memory device 6230 may correspond to the memory device 150 in the memory system 110 described with reference to FIG. 1, and the memory controller 6220 may correspond to the controller 130 in the memory system 110 described with reference to FIG. 1.

The memory controller 6220 controls a read operation, a write operation, an erase operation, and the like, for the memory device 6230 in response to a request from the host 6210. The memory controller 6220 is shown to include one or more CPUs 6221, a buffer memory, for example, a RAM 6222, an ECC circuit 6223, a host interface 6224, and a memory interface, for example, an NVM interface 6225.

The CPU 6221 may control the general operation, for example, a read operation, a write operation, a file system management, and/or a bad page management, for the memory device 6230. Further, the RAM 6222 may be operated under a control of the CPU 6221, and may be used as a work memory, a buffer memory, a cache memory, and the like. When the RAM 6222 is used as a work memory, data processed in the CPU 6221 may be temporarily stored, and when the RAM 6222 is used as a buffer memory, the RAM 6222 may be used for buffering data that is transmitted from the host 6210 to the memory device 6230 or from the memory device 6230 to the host 6210. When the RAM 6222 is used as a cache memory, the RAM 6222 may be used so that the memory device 6230, having a low speed, is operated at a high speed.

For some embodiments, the ECC circuit 6223 corresponds to the ECC unit 138 of the controller 130 described with reference to FIG. 1. As described with reference to FIG. 1, the ECC circuit 6223 generates an ECC for correcting a fail bit or an error bit of data received from the memory device 6230. Further, the ECC circuit 6223 forms data to which a parity bit is added by performing error correction encoding on data provided to the memory device 6230. Herein, the parity bit may be stored in the memory device 6230. Further, the ECC circuit 6223 may perform the error correction decoding on data output from the memory device 6230, and in this case, the ECC circuit 6223 may correct an error by using parity. For example, the ECC circuit 6223 may correct the error by using various coded modulations, such as an LDPC code, a BCH code, a turbo code, a reed-Solomon code, a convolution code, an RSC, a TCM, and/or a BCM, as described with reference to FIG. 1.

The memory controller 6220 transceives data and the like with the host 6210 through the host interface 6224, and transceives data and the like with the memory device 6230 through the NVM interface 6225. Herein, the host interface 6224 may be connected with the host 6210 through a PATA bus, a SATA bus, an SCSI, a USB, a PCIe, a NAND interface, and/or the like. Further, the memory controller 6220 may be implemented with a wireless communication function, such as WiFi or Long Term Evolution (LTE), or other mobile communication standard, connected with an external device, for example, the host 6210 or another external device. The memory controller 6220 may then transceive data and the like. For some embodiments, the memory controller 6220 is configured to communicate with an external device through at least one of various communication standards, so that the memory system 110 and the data processing system may be applied to wired and wireless electronic devices, and in particular, to mobile electronic devices.

FIG. 10 is a diagram schematically illustrating another example of a data processing system including the memory system 110. In particular, FIG. 10 schematically illustrates an SSD used with the memory system 101.

Referring to FIG. 10, an SSD 6300 includes a memory device 6340, which includes a plurality of nonvolatile memories, and a controller 6320. For some embodiments, the controller 6320 may correspond to the controller 130 in the memory system 110, described with reference to FIG. 1, and the memory device 6340 may correspond to the memory device 150 in the memory system 110, also described with reference to FIG. 1.

The controller 6320 is shown connected with the memory device 6340 through a plurality of channels CH1, CH2, CH3, . . . , and CHi. Further, the controller 6320 includes one or more processors 6321, a buffer memory 6325, an ECC circuit 6322, a host interface 6324, and a memory interface, for example, a nonvolatile memory device 6326.

The buffer memory 6325 temporarily stores data received from the host 6310 or from a plurality of flash memories NVMs included in the memory device 6340, or temporarily stores meta-data of the plurality of flash memories NVMs, for example, map data including a mapping table. Further, the buffer memory 6325 may be implemented with a volatile memory, such as a DRAM, an SDRAM, a DDR SDRAM, an LPDDR SDRAM, and/or a GRAM, or it may be implemented with a nonvolatile memory, such as an FRAM, a ReRAM, an STT-MRAM, and/or a PRAM. In the embodiment shown, the buffer memory 6325 is located inside the controller 6320. In other embodiments, the buffer memory 6325 may be located outside the controller 6320.

The ECC circuit 6322 calculates an error correction code value of data that is to be programmed to the memory device 6340 in a program operation. The ECC circuit 6322 further performs an error correction operation based on an error correction code value of data read from the memory device 6340 in a read operation, and performs an error correction operation of data restored from the memory device 6340 in a restoration operation of failed data.

The host interface 6324 provides an interface function with an external device, for example, the host 6310. The nonvolatile memory interface 6326 provides an interface function with the memory device 6340 connected through the plurality of channels CH1, CH2, CH3, . . . , CHi.

Further, when the SSD 6300 represents a plurality of SSDs, the plurality of SSDs 6300, to which the memory system 110 described with reference to FIG. 1 is applied, is applied to implement a data processing system, for example, a Redundant Array of Independent Disks (RAID) system, and in this case, the RAID system may include a plurality of SSDs 6300 and an RAID controller controlling the plurality of SSDs 6300. Herein, when the RAID controller receives a write command from the host 6310 and performs a program operation, the RAID controller may select one or more memory systems, that is, the SSD 6300, among the plurality of RAID levels, that is, the plurality of SSDs 6300, in accordance with RAID level information of the write command received from the host 6310, and then output the data corresponding to the write command to the selected SSD 6300. Further, when the RAID controller receives a read command from the host 6310 and performs a read operation, the RAID controller may select one or more memory systems, that is, the SSD 6300, among the plurality of RAID levels, that is, the plurality of SSDs 6300, in accordance with RAID level information of the read command received from the host 6310, and then provide the data from the selected SSD 6300 to the host 6310.

FIG. 11 is a diagram schematically illustrating another example of a data processing system, which includes the memory system 110, in accordance with an exemplary embodiment of the present disclosure. In particular, FIG. 11 shows an eMMC used with the memory system 110.

Referring to FIG. 11, an eMMC 6400 includes a memory device 6440 implemented with one or more NAND flash memories, and a controller 6430. For some embodiments, the controller 6430 may correspond to the controller 130 in the memory system 110, described with reference to FIG. 1, and the memory device 6440 may correspond to the memory device 150 in the memory system 110, also described with reference to FIG. 1.

The controller 6430 is shown to include one or more cores 6432, a host interface 6431, and a memory interface, for example, a NAND interface 6433. The core 6432 controls a general operation of the eMMC 6400, the host interface 6431 provides an interface function between the controller 6430 and the host 6410, and the NAND interface 6433 provides an interface function between the memory device 6440 and the controller 6430. For some embodiments, the host interface 6431 may be a parallel interface, for example, an MMC interface, as described with reference to FIG. 1, and further, may be a serial interface, for example, an Ultra High Speed (UHS)-I/UHS-II interface and/or a UFS.

The detailed description of the present disclosure includes the description of exemplary embodiments. Various modifications can be made to the described embodiments without departing from the scope or the technical spirit of the present disclosure. Therefore, the scope of the present disclosure shall not be limited to the exemplary embodiments described herein, but shall rather be defined by the claims presented below and equivalents thereof.

What is claimed is:

1. A memory system, comprising:
a memory device including a plurality of memory blocks in which data is stored; and
a controller configured to:
perform a command operation, corresponding to a command received from a host;
perform a garbage collection operation, in such a manner as to stop the ongoing garbage collection operation when a system termination command is input from the host during the garbage collection operation; and
transmit a signal, corresponding to the system termination command, to the host.

2. The memory system of claim 1, wherein the controller is further configured to stop the garbage collection operation and generate a context for the stopped garbage collection operation.

3. The memory system of claim 2, wherein the context includes information indicating whether the ongoing garbage collection operation is normally performed, an address of a last page of a source block of the plurality of memory blocks, and an address of a last page of a target block of the plurality of memory blocks.

4. The memory system of claim 2, wherein one or more memory blocks among the plurality of memory blocks are defined as system blocks storing system data, and wherein the system blocks store the context when the system termination command is input.

5. The memory system of claim 4, wherein the controller is further configured to read and store the system data and the context stored in the system blocks during a power-on operation and perform a booting operation according to the stored system data.

6. The memory system of claim 5, wherein the controller is further configured to re-perform the stopped garbage collection operation from a stopped part, based on the context, after the booting operation is completed.

7. The memory system of claim 1, wherein the controller is further configured to perform the garbage collection operation when a number of empty memory blocks among the plurality of memory blocks is smaller than a predetermined number.

8. The memory system of claim 1, wherein the controller is further configured to, during the garbage collection operation, copy and store data of valid pages included in a source block, in which a program operation is completed, to a target block, in which the program operation is not performed, wherein the source block and the target block are included in the plurality of memory blocks.

9. The memory system of claim 8, wherein the controller is further configured to erase the source block when the data is copied and is stored in the target block.

10. A memory system, comprising:
a memory device including one or more system blocks and a plurality of memory blocks; and
a controller configured to perform a command operation, corresponding to a command received from a host, and a garbage collection operation, wherein the controller is further configured to:
stop the ongoing garbage collection operation and then terminate the system when a system termination command is input during the garbage collection operation; and
perform a booting operation and re-perform the stopped garbage collection operation from a stopped part when the system is powered on after the termination of the system.

11. The memory system of claim 10, wherein the controller is further configured to:
stop the garbage collection operation;
generate a context for the stopped garbage collection operation; and
store the generated context in the one or more system blocks.

12. The memory system of claim 11, wherein the context includes information indicating whether the ongoing garbage collection operation is normally performed, an address of a last page of a source block, and an address of a last page of a target block.

13. The memory system of claim 11, wherein the controller is further configured to:
read and store the system data and the context stored in the system blocks during the power-on operation; and
perform the booting operation according to the stored system data.

14. The memory system of claim 11, wherein the controller is further configured to re-perform the stopped garbage collection operation based on the context after the booting operation is completed.

15. The memory system of claim 10, wherein the controller is further configured to, during the garbage collection operation, copy and store data of valid pages included in a source block, in which a program operation is completed, to a target block, in which the program operation is not performed, wherein the source block and the target block are included in the plurality of memory blocks.

16. The memory system of claim 15, wherein the controller is further configured to erase the source block when the data is copied and is stored in the target block.

17. A method of operating a memory system, the method comprising:
providing a memory system, wherein the memory system includes a memory device, having a plurality of memory blocks, and a controller, for controlling the memory device;
when a command is input into the memory system from a host, performing a command operation corresponding to the command;
when a number of empty memory blocks among the plurality of memory blocks is smaller than a predetermined number, performing a garbage collection operation;
when a system termination command is input from the host during the garbage collection operation, stopping the ongoing garbage collection operation, transmitting a response signal for the system termination command to the host, and terminating the memory system; and
when the memory system is powered on, performing a booting operation, and re-performing the stopped garbage collection operation from a stopped part after the booting operation.

18. The method of claim 17, wherein terminating the memory system includes stopping the garbage collection operation, generating a context for the stopped garbage collection operation, and storing the generated context in a system block included in the plurality of memory blocks.

19. The method of claim 18, wherein the context includes information indicating whether the ongoing garbage collection operation is normally performed, an address of a last page of a source block, and an address of a last page of a target block, wherein the source block and the target block are included in the plurality of memory blocks.

20. The method of claim 18, wherein the context stored in the system block is read during the booting operation, and the stopped garbage collection operation is re-performed from a stopped part based on the read context after the booting operation is completed.
